(19) United States
(12) Patent Application Publication
(10) Pub. No.: US 2014/0237598 A1
(43) Pub. Date: Aug. 21, 2014

(54) Reducing the Spread of Viruses and Errors in Social Networks and Affinity Groups

(71) Applicant: INTERNATIONAL BUSINESS MACHINES CORPORATION, (US)

(72) Inventors: Judith H. Bank, Morrisville, NC (US); Liam Harpur, Dublin (IE); Ruthie D. Lyle, Durham, NC (US); Patrick J. O'Sullivan, Dublin (IE); Lin Sun, Morrisville, NC (US)

(73) Assignee: INTERNATIONAL BUSINESS MACHINES CORPORATION, Armonk, NY (US)

(21) Appl. No.: 13/769,458

(22) Filed: Feb. 18, 2013

(51) Int. Cl. H04L 29/06

(52) U.S. Cl. CPC H04L 63/145
USPC 726/24

(57) ABSTRACT

An approach is provided to reduce the spread of malware within a group of users. In the approach, a malware program (e.g., virus, Trojan, worm, etc.) is detected at a system that is utilized by one of the users that is a member of a peer affinity group. Event data pertaining to the detected malware program is gathered at the user's system. A notification is provided to the other users included in the peer affinity group. The notification identifies the detected malware program and the event data that was gathered at the user's system.

### TECHNICAL FIELD

The present disclosure relates to an approach that reduces the spread of malware in social networks and affinity groups with improved communication techniques.

### BACKGROUND OF THE INVENTION

Many malicious software (malware) programs such as viruses, Trojans, and worms are easily spread to or between users that belong to a common group. The group can include users in contact lists or colleagues in a social network environment. The malware is often transmitted through electronic mail (email), Instant Messaging (IM), shared documents, or based upon common network proximity. Furthermore, members of an affinity group, such as a department, organization, or business, are subject to encountering identical software or Web site errors because they use many of the same common Internet resources, shared documents and software packages. The current art does not provide a mechanism to warn or alert users and system administrators in the social network or affinity group when an error or a malware infection is detected in order to prevent the problem from spreading to others in the group.

### SUMMARY

An approach is provided to reduce the spread of a malware program within a group of users. In the approach, a malware program (e.g., virus, Trojan, worm, etc.) is detected at a system that is utilized by one of the users that is a member of a peer affinity group. Event data pertaining to the detected malware program is gathered at the user's system. A notification is provided to the other users included in the peer affinity group. The notification identifies the detected malware program and the event data that was gathered at the user's system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in alerting users of a common group that one of the group's members has encountered a malware program;

FIG. 4 is a depiction of a flowchart showing the logic used in malware program detection and analysis by a member of the group;

FIG. 5 is a depiction of a flowchart showing the logic used in the communication to other members of the group providing details of a malware infection by one of the group's members; and

FIG. 6 is a depiction of a flowchart showing the steps pertaining to malware resolution and resolution notification to the group members.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

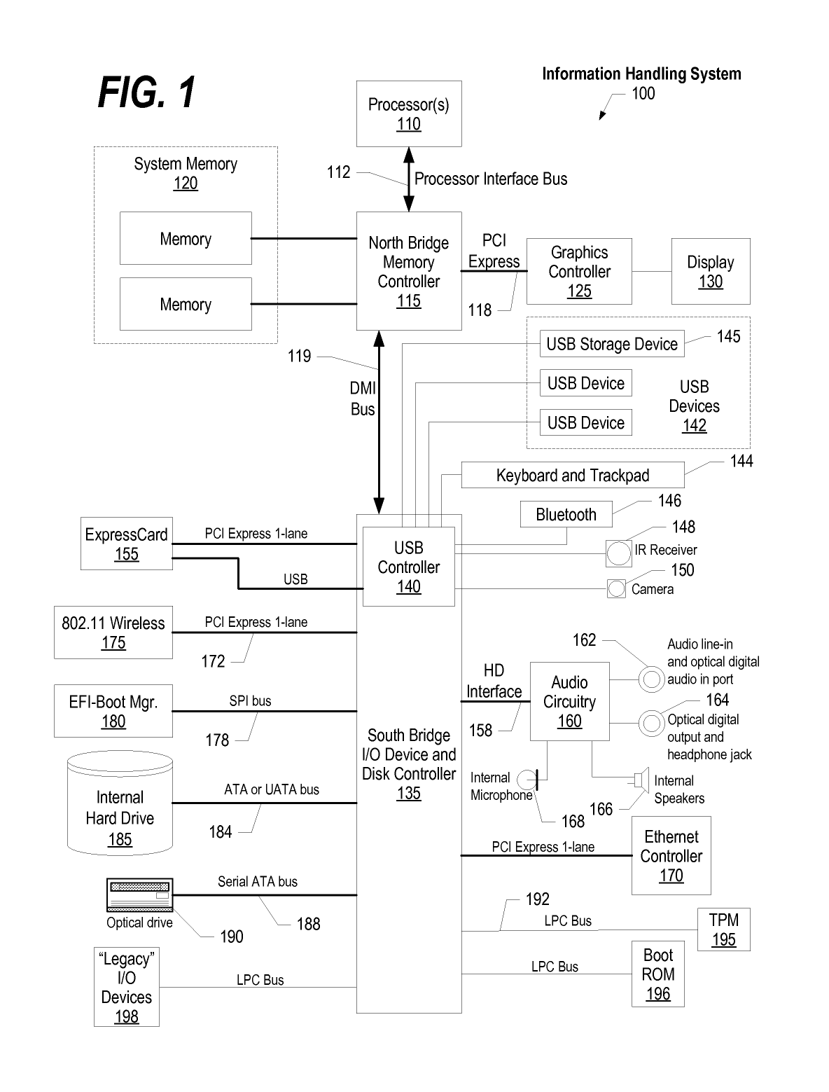

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

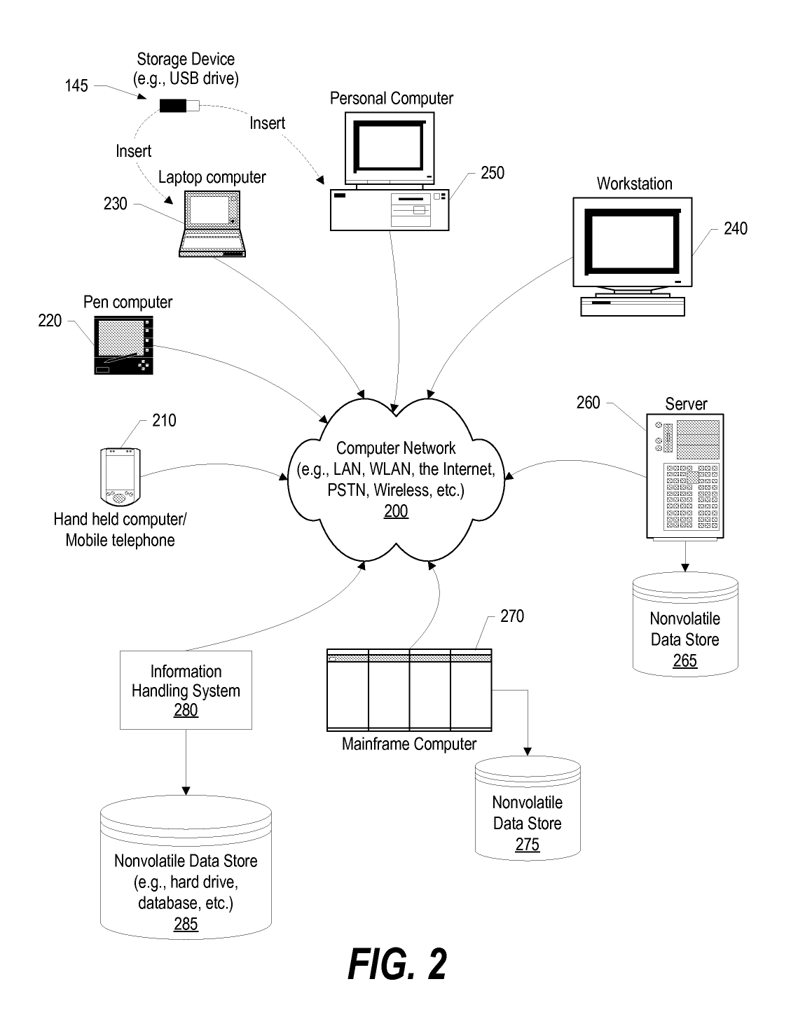

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

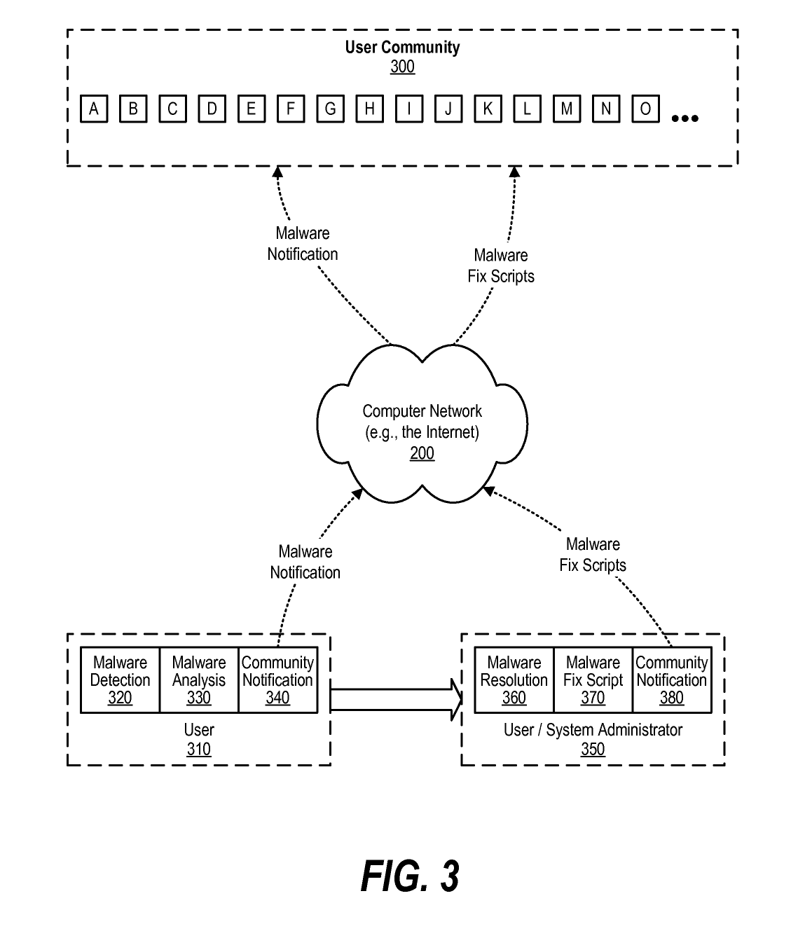

FIGS. 3-6 depict an approach that can be executed on an information handling system, such as a mobile device, and computer network as shown in FIGS. 1-2. An approach is provided for communicating errors and descriptions of malware infections detected on a computer belonging to a member of a group or social network along with additional information to identify likely sources of the problem. The objective is to pro-actively prevent others from encountering it. It also notifies those same users of a solution to the error or sends them instructions for virus removal, when either is subsequently identified. Optionally, identified errors or infections could trigger an automated Web search for the same or similar problems and additional information could be communicated. This approach could be implemented on a wide variety of electronic devices such as mobile phones, tablet computers, assembly line robots, pipeline control mechanisms, water treatment plants security systems, etc.

When a malware program is detected (for example by an anti-virus program or browser plugin), the approach analyzes the state of the affected computer and inspects various logs and files contained therein. For example, if a file containing a virus is identified, it likely has a creation time and date. This data is correlated with entries in files that maintain system status information such as logs, the system registry, etc. If the rogue file is detected by an anti-virus scanner or spyware scanner, the date of the last previous scan is normally available. This usually implies that the infestation most likely occurred after that time and date. In this way, analysis software determines the events that might be related to the introduction of the infection.

Malware programs can also be introduced by documents, graphic images, or external disk drives, and may not have originated in a network. Most pro-active antivirus solutions involve analysis of a network and are ineffective if viruses have not yet spread to the network. Similarly, for application or operating system errors, it is often possible to find events that may have precipitated the error, such as upgrade to a new software level, new fix applied, installation of a new application, use of a specific input file or certain input parameters, etc. The approach includes a communication system that warns other group members of the problem. Such notification is helpful for enterprises that employ automatic synchronized software updates. While traditional problem analysis solutions correlate previous problem events with the current problem event (e.g. disk drive started failing), the approach provided herein correlates user actions or events that might inherently seem benign (such as user access of a Web site). Using the above information, an analysis program identifies probable causes of a problem and notifies other users, such as system administrators, in order to prevent the problem from spreading.

In addition, the malware analysis program notifies and warns other users to avoid the Web page, email, document, external disk, update or down loaded program, etc. identified as the likely cause and thereby prevents them from encountering the same issue. In some cases, such as encountered with a network worm, the approach may additionally scan outgoing alert messages in order to ascertain that such messages do not themselves contain the malware program (network worm). Using the same communication mechanism, users or administrators can notify other users of solutions or virus removal instructions when they become available. Furthermore, discovered infections could trigger a Web search for the same or similar problems reported elsewhere and additional information could be communicated to the designated parties. FIGS. 3-6 provide further details related to one or more embodiments that reduce the spread of malware programs in peer affinity groups such as those found in social networks and other affinity groups.

FIG. 3 is a component diagram showing the various components used in alerting users of a common group that one of the group's members has encountered a malware program. User community 300 includes a number of users, such as those found in a social network group (e.g., “friends,” “contacts,” etc.), a user contact list, an organization contact list, a department contact list, and a business contact list. User 310 is a member of user community 300. User 310 detects a malware program on the user's system using malware detection process 320 (e.g., using antivirus software, anti-spyware software, etc.). Malware analysis process 330 is then performed in order to identify events that occurred at the user's system prior to the infection of the detected malware program. Events can include network sites (e.g., Websites, etc.) visited, files accessed (e.g., executables, multimedia files, etc.), accessed data sources (e.g., databases, data stores, etc.), and communications received at the user's system (e.g., email messages, streamed content, instant message content, etc.). The malware analysis identifies event data that is likely related to the infection of the user's system of the detected malware program. Community notification process 340 is performed to inform the user community of the infestation of the detected malware program and the gathered event data. In this manner, other members of user community 300 can avoid infection by refraining from performing the events described in the event data (e.g., refraining from visiting a particular Website, refraining from running a particular executable or accessing a particular file, refraining from opening a communication, such as an email, sent to the user community by a third party, etc.).

After a malware notification has been sent to user community 300, the user with the infected system as well as system services personnel, such as system administrators 350, work on resolving the malware infection. Malware resolution process 360 is performed by the user and such other system services personnel. Once a resolution has been developed to recover from the malware infestation (e.g., remove the malware from the system, changes made by the malware to system registries, etc.), a malware fix script is developed in process 370. As the name implies, the malware fix script is a script, either automated or manual, that resolves the malware issue. Community notification process 380 is performed to notify user community 300 that a resolution has been developed for the malware program as well as provide the malware fix script to the user community (e.g., a link to the fix script that can be downloaded, attached to an email used as part of the notification process, etc.). In this manner, any members of the user community that were also infected by the malware program (e.g., before the community notification was sent by process 340, etc.) are informed of the resolution as well as instructions as to how to resolve the malware infestation.

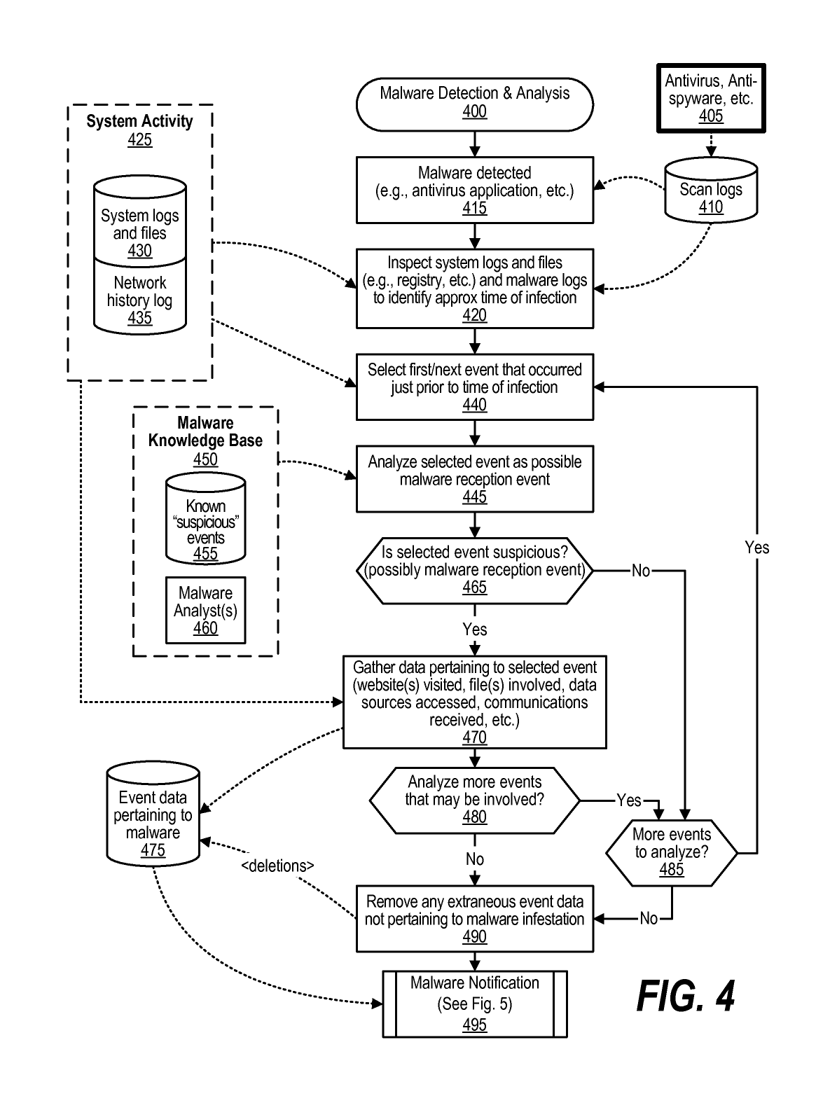

FIG. 4 is a depiction of a flowchart showing the logic used in malware detection and analysis by a member of the group. The malware detection and analysis process commences at 400 whereupon, at step 415, a malware program is detected at the user's system. The detection may be made external detection programs 405, such as by antivirus software, anti-spyware software, etc. The malware detection process records malware program detections in scan logs 410.

At step 420, the malware detection and analysis process inspects system logs and other files, such as system registries, etc., along with scan logs 410 maintained by the malware detection software, to identify an approximate time that the system was infected by the detected malware program. System activity files 425 include both system logs and files 430 (e.g., registry files, logs, etc.) as well as network history logs (e.g., browser histories, etc.). At step 440, the first event that occurred just prior to the identified time of infection is selected from the system activity files. At step 445, the selected event (event data) is analyzed to determine if the selected event is related to the reception of the detected malware program. In one embodiment, the analysis utilizes malware knowledge base 450 which includes both a list of known “suspicious” activities 455 as well as input from human malware analysts 460. Different environments may utilize different combinations of malware knowledge bases depending on availability, etc.

A decision is made, based on the analysis performed at step 445, as to whether the selected event is a suspicious event that might possibly be related to the infestation of the system by the detected malware program (decision 465). If the selected event is a suspicious event that might possibly be related to the infestation of the system by the detected malware program, then decision 465 branches to the “yes” branch whereupon at step 470 the process gathers event data pertaining to the selected event (website(s) visited, file(s) involved, data sources accessed, communications received, etc.). As shown, the event data is gathered from system activity data 425 which includes system logs and files (data store 430) as well as network activity logs (data store 435). After the data pertaining to the selected event has been gathered and stored in data store 475, a decision is made as to whether there are more events to analyze that may be related to the malware infestation (decision 480). If there are more events that may be involved, decision 480 branches to the “yes” branch whereupon a decision is made as to whether there are additional events in the timeframe preceding the approximate time of malware infestation to analyze (decision 485). If there are additional events to analyze, then decision 485 branches to the “yes” branch which loops back to select and process the next event that occurred prior to the time of malware infestation as described above. This looping continues until either there are no more events to analyze in the timeframe preceding the infestation (with decision 485 branching to the “no” branch) or if the user or other decision maker has determined that no more events are likely to be involved in the infestation (with decision 480 branching to the “no” branch).

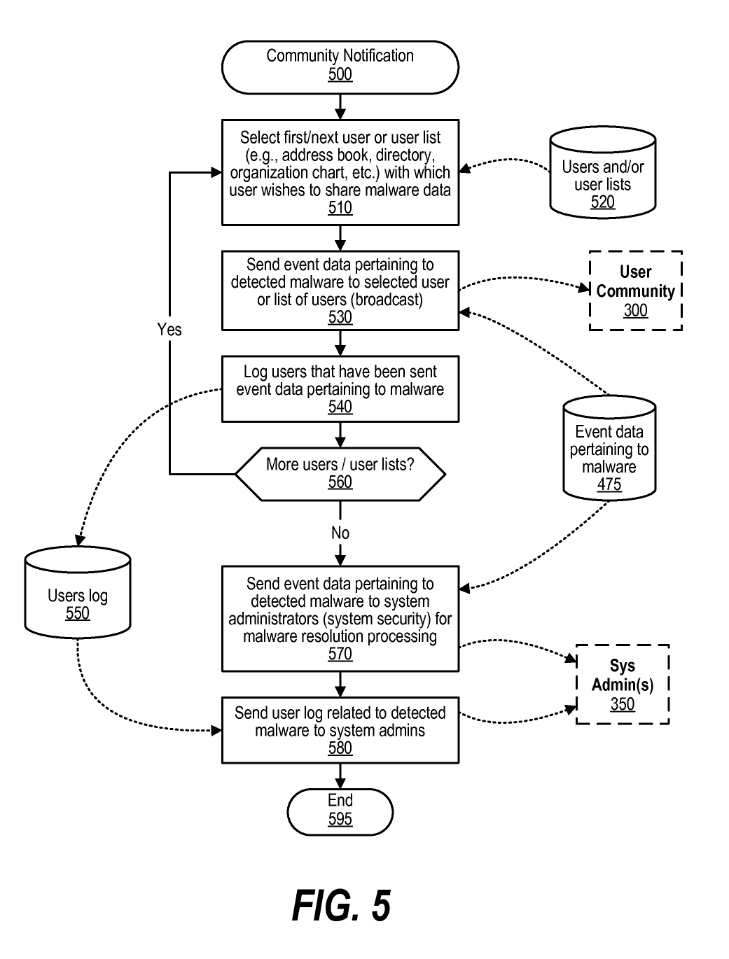

At this point, step 490, any extraneous event data that does not pertain to the malware infestation but was previously stored in data store 475 is removed. For example, a Website that was visited may have appeared to be suspicious but, after analyzing all of the events, it may have been determined that the visited Website was benign and that a network file that was executed was the event that led to the malware infestation. At predefined process 495, the user community is notified of the malware infestation as well as provided with the event data (e.g., Websites visited, network files accessed, communications received, etc.) that was related to the malware infestation (see FIG. 5 and corresponding text for processing details).

FIG. 5 is a depiction of a flowchart showing the logic used in the communication to other members of the group providing details of a malware infection by one of the group's members. The community notification process commences at 500 whereupon, at step 510, the process selects the first user or user list (e.g., address book, social media contacts, directory, organization chart, etc.) with which user wishes to share malware program data. The user and/or user lists are retrieved from data store 520. At step 530, the malware infestation detection is sent to the selected users or user list along with the event data that was gathered at the system where the infestation occurred. In this manner, other members of user community 300 can avoid infection by refraining from performing the events described in the event data (e.g., refraining from visiting a particular Website, refraining from running a particular executable or accessing a particular file, refraining from opening a communication, such as an email, sent to the user community by a third party, etc.). At step 540, a log is maintained of the users or user lists that have been notified of the malware program and the event data related to the malware infestation. The log is maintained in data store 550. A decision is made as to whether there are more users or lists of users to whom the malware program detection and event data should be sent (decision 560). If there are more users or user lists, then decision 560 branches to the “yes” branch which loops back to select the next user or user list and sends the malware program notification as described above. This looping continues until there are no more users or user lists with whom the user wishes to share the malware program detection and event data, at which point decision 560 branches to the “no” branch for further processing.

At step 570, the process sends the malware program detection and event data pertaining to the malware infestation to system administrators 350, such as system security personnel, for assistance in resolving the malware infestation. In addition, at step 580, the process sends user log 550 (or a link to the user log) to the system administrators so that the system administrators are aware of the users in the user community that have been informed of the malware infestation and the event data pertaining to the malware program. Community notification processing thereafter ends at 595.

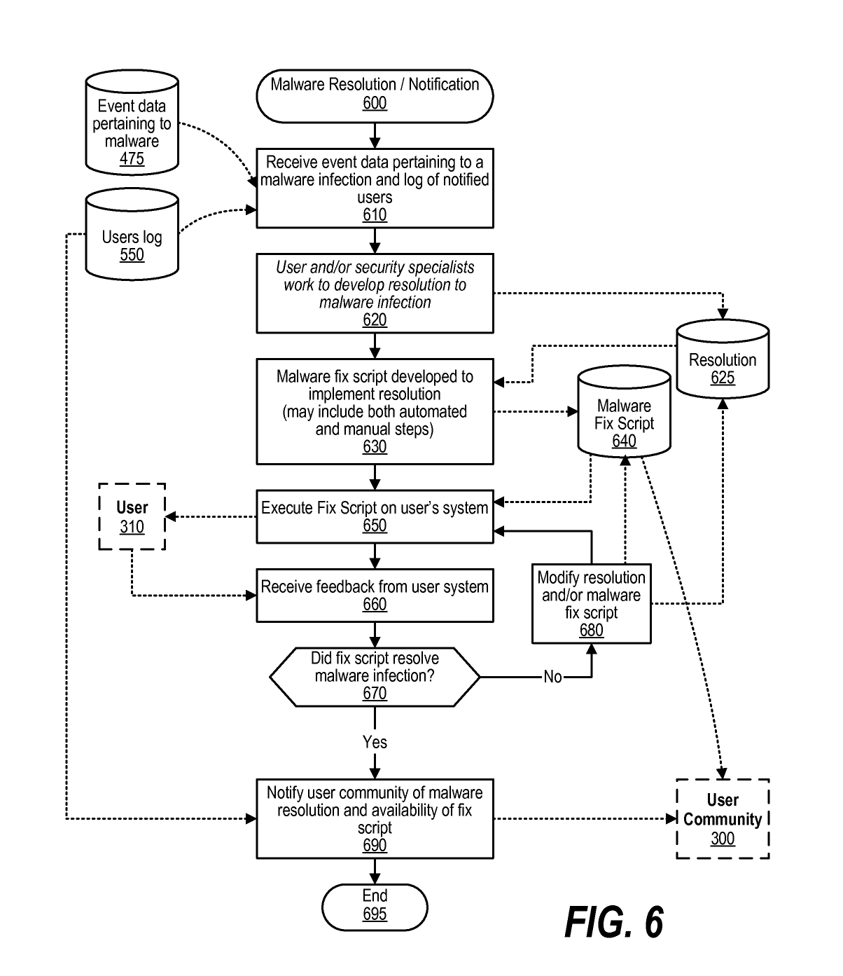

FIG. 6 is a depiction of a flowchart showing the steps pertaining to malware program resolution and resolution notification to the group members. Malware program resolution and resolution notification processing commences at 600 whereupon, at step 610, the event data pertaining to the malware infestation is received along with a log of the users that have been sent notifications regarding the infestation (data store 550). At step 620, the user and/or the system administrators work to develop a resolution to the malware infestation experienced by the user. The resolution is stored in resolution data store 625.

At step 630, a malware fix script is developed with steps that execute the identified resolution stored in data store 625. The malware fix script may include a combination of manual as well as automated processes used to resolve the malware infestation. The malware fix script is stored in data store 640. At step 650, the malware fix script is tested by executing the script on the user's (infected) system (user's system 310). At step 660, feedback is received from the user's system pertaining to the effectiveness of the malware fix script in resolving the malware infestation. A decision is made based on the received feedback as to whether the fix script effectively resolved the malware infestation (decision 670). If the malware fix script did not effectively resolve the malware infestation, then decision 670 branches to the “no” branch whereupon, at step 680, the resolution and/or the malware fix script are modified to address the current fix script shortcomings. This looping continues until the malware fix script has been developed that effectively resolves the malware infestation, at which point decision 670 branches to the “yes” branch for notification processing.

At step 690, the user community is notified of the malware resolution and provided with the malware fix script. The user community of previously notified users is retrieved from data store 550. In this manner, any members of user community 300 that were also infected by the malware program are informed of the resolution as well as instructions, contained in the malware fix script, as to how to resolve the malware infestation. Malware resolution and resolution notification processing thereafter ends at 695.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of notifying a peer affinity group of a malware program, the method, implemented by an information handling system, comprising:
detecting the malware program by the information handling system, wherein the information handling system is utilized by a first user that is a member of the peer affinity group;
gathering a plurality of event data from one or more accessible data sources by the first user's information handling system, wherein the event data pertains to the detected malware program; and
transmitting, by the first user's information handling system, a notification to a plurality of users included in the peer affinity group, wherein the notification identifies the detected malware program and includes the gathered event data.

2. The method of claim 1 wherein the peer affinity group is selected from the group consisting of a social media group, a user contact list, an organization contact list, a department contact list, and a business contact list.

3. The method of claim 1 further comprising:
identifying a time of infection corresponding to the detected malware program at the information handling system, wherein a plurality of events corresponding to the gathered event data occurred prior to the identified time of infection.

4. The method of claim 3 wherein the events are selected from the group consisting of visited network sites, accessed files, accessed data sources, and communications received at the information handling system.

5. The method of claim 3 further comprising:
analyzing the plurality of events;
identifying one or more extraneous events unrelated to the detected malware program; and
removing the event data corresponding to the extraneous events from the plurality of gathered event data included in the notification.

6. The method of claim 5 wherein the analysis of the plurality of events further comprises:
retrieving one or more known suspicious events from a data store;
comparing the known suspicious events to the plurality of events; and
in response to the comparing, identifying each of the plurality of events that match one of the known suspicious events as one of the gathered event data included in the notification.

7. The method of claim 1 further comprising:
developing a malware fix script, wherein the malware fix script resolves one or more problems associated with the detected malware program;
notifying the plurality of user of the development of the malware fix script; and
providing the malware fix script to the plurality of users.

8. An information handling system comprising:
a plurality of processors;
a memory coupled to at least one of the processors;
a set of instructions stored in the memory and executed by at least one of the processors to reduce a malware infestation, wherein the set of instructions perform actions of:
detecting the malware program by the information handling system, wherein the information handling system is utilized by a first user that is a member of the peer affinity group;
gathering a plurality of event data from one or more accessible data sources by the first user's information handling system, wherein the event data pertains to the detected malware program; and
transmitting, by the first user's information handling system, a notification to a plurality of users included in the peer affinity group, wherein the notification identifies the detected malware program and includes the gathered event data.

9. The information handling system of claim 8 wherein the peer affinity group is selected from the group consisting of a social media group, a user contact list, an organization contact list, a department contact list, and a business contact list.

10. The information handling system of claim 8 wherein the actions performed further comprise:
identifying a time of infection corresponding to the detected malware program at the information handling system, wherein a plurality of events corresponding to the gathered event data occurred prior to the identified time of infection.

11. The information handling system of claim 10 wherein the events are selected from the group consisting of visited network sites, accessed files, accessed data sources, and communications received at the information handling system.

12. The information handling system of claim 10 actions performed further comprise:
analyzing the plurality of events;
identifying one or more extraneous events unrelated to the detected malware program;
removing the event data corresponding to the extraneous events from the plurality of gathered event data included in the notification;
retrieving one or more known suspicious events from a data store;
comparing the known suspicious events to the plurality of events; and
in response to the comparing, identifying each of the plurality of events that match one of the known suspicious events as one of the gathered event data included in the notification.

13. The information handling system of claim 8 actions performed further comprise:
developing a malware fix script, wherein the malware fix script resolves one or more problems associated with the detected malware program;
notifying the plurality of user of the development of the malware fix script; and
providing the malware fix script to the plurality of users.

14. A computer program product stored in a computer readable medium, comprising computer instructions that, when executed by an information handling system, causes the information handling system to perform actions comprising:
detecting the malware program by the information handling system, wherein the information handling system is utilized by a first user that is a member of the peer affinity group;
gathering a plurality of event data from one or more accessible data sources by the first user's information handling system, wherein the event data pertains to the detected malware program; and
transmitting, by the first user's information handling system, a notification to a plurality of users included in the peer affinity group, wherein the notification identifies the detected malware program and includes the gathered event data.

15. The computer program product of claim 14 wherein the peer affinity group is selected from the group consisting of a social media group, a user contact list, an organization contact list, a department contact list, and a business contact list.

16. The computer program product of claim 14 further comprising:
identifying a time of infection corresponding to the detected malware program at the information handling system, wherein a plurality of events corresponding to the gathered event data occurred prior to the identified time of infection.

17. The computer program product of claim 3 wherein the events are selected from the group consisting of visited network sites, accessed files, accessed data sources, and communications received at the information handling system.

18. The computer program product of claim 17 further comprising:
analyzing the plurality of events;
identifying one or more extraneous events unrelated to the detected malware program; and
removing the event data corresponding to the extraneous events from the plurality of gathered event data included in the notification.

19. The computer program product of claim 17 wherein the analysis of the plurality of events further comprises:
retrieving one or more known suspicious events from a data store;
comparing the known suspicious events to the plurality of events; and
in response to the comparing, identifying each of the plurality of events that match one of the known suspicious events as one of the gathered event data included in the notification.

20. The computer program product of claim 14 further comprising:
developing a malware fix script, wherein the malware fix script resolves one or more problems associated with the detected malware program;
notifying the plurality of user of the development of the malware fix script; and
providing the malware fix script to the plurality of users.
